(19) United States
(12) Patent Application Publication
(10) Pub. No.: US 2019/0390692 A1
(43) Pub. Date: Dec. 26, 2019

(54) A RETAINING CLIP

(71) Applicant: Guangdong Sirui Optical Co., Ltd., Zhongshan (CN)

(72) Inventors: Jie Li, Zhongshan (CN); Xiaoyun Hu, Zhongshan (CN)

(73) Assignee: GUANGDONG SIRUI OPTICAL CO., LTD., Zhongshan (CN)

(21) Appl. No.: 15/544,519

(22) PCT Filed: Apr. 5, 2017
(86) PCT No.: PCT/CN2017/079412

§ 371 Date: Jul. 18, 2017

(30) Foreign Application Priority Data
Mar. 9, 2017 (CN) 201710138230.8

(51) Int. Cl. F16B 2/12; F16M 13/02; F16B 2/00; H04M 1/04

(52) U.S. Cl. CPC F16B 2/12; F16M 13/02; F16M 2200/028; H04M 1/04; F16B 2/005

(57) ABSTRACT

A retaining clip includes a first clamping component; a second clamping component, which is movably connected with the first clamping component. The first clamping component and the second clamping component respectively have a clamping surface facing each other in a moving direction thereof. A locking mechanism locks a piece clamped between the clamping surfaces of the first clamping component and the second clamping component and releasing the locking of the piece clamped. The locking mechanism comprises locking teeth, disposed on the first clamping component or the second clamping component along a sliding direction. A brake assembly, disposed on the second clamping component or the first clamping component, comprises at least a brake component movably mounted on the slide component, with a brake end of the brake component movable between an engaging position and an disengaging position of the locking tooth.

### CROSS REFERENCE TO RELATED APPLICATION

This is a national entry application of a PCT international patent application serial no. PCT/CN2017/079412, filed on Apr. 5, 2017, which further claims a Chinese patent application filed on Mar. 9, 2017, serial number 201710138230.8, whose disclosures are incorporated by reference in its entirety herein.

### TECHNICAL FIELD

The present invention relates to the technical field of electronic products, and more particularly to a retaining clip that provides auxiliary fixation for mobile phones, photographic camera products, or other electronic products.

### BACKGROUND

As the photographing of mobile phones, Flip cameras, EVIL cameras and other electronic products becomes more and more powerful, the above mentioned more portable electronic products may also produce high quality video works, in order to further improve the picture quality, a skilled person in the art designs a retaining clip, which is a clip that may provide retaining, for example, a mobile phone retaining clip which may retain a mobile phone relying on devices such as a tripod. Thus the shaking of mobile phone may be well prevented at the time of photographing, so as to improve the quality of the pictures and the capability of photographing for night view; in addition, the emergence of mobile phone clips also provides more methods of using the photographic equipment, for example, Bluetooth may be used to control the shutter to take self-portraits from a third person perspective; or for example, delay the camera to complete a third person perspective through a self-timer; or move the phone clip up or down to show a non-conventional perspective. A retaining clip may not only be used in the field of photography, but also be used in the scenarios of interviews, recording, etc.

The conventional clip structure is complicated. For example, it includes a movable clamp provided with a movable clamp reduction device and a movable clamp locking device, a fixing device that may fix the movable clamp onto the tripod is provided at the bottom of the movable clamp. Wherein the movable clamp locking device comprises a rack provided on one side of a first clamping component rail and a gear engaged with the rack provided on a second clamping component, and the second clamping component is further provided with a brake bar and a brake bar fixing device, one end of the brake bar is insertable into the tooth groove of the gear for locking the first clamping component. In the locking device of the mobile phone clip, the rack and pinion need to coordinate with each other to satisfy the demand of locking the image capturing devices such as a mobile phone by only pressing the first clamping component and the second clamping component, and driving the brake bar to disengage from the gear to release the lock while the push button is being pressed. Wherein the application of gears requires a certain amount of space, which makes the size of the clips bloated. When it is required to unlock, a button needs to press to actuate the brake bar to release the lock on the gear, so as to release the lock of the gear on the rack, it may be seen that the number of components in the locking device is large, the structure is complex and the production cost is high.

### SUMMARY

Accordingly, the technical problem to be solved by the present invention is how to overcome the defects of complex structure and large size of the retaining clips in the prior art, thereby providing a retaining clip with a reasonable structural design and a relatively low production cost.

In order to solve the above technical problems, the present invention provides a retaining clip, comprising a first clamping component; a second clamping component, which is movably connected with the first clamping component, wherein, the first clamping component and the second clamping component respectively have a clamping surface facing each other in a moving direction thereof; a locking mechanism, for locking a piece clamped between the clamping surfaces of the first clamping component and the second clamping component and releasing the locking of the piece clamped; wherein, the locking mechanism comprises locking teeth, disposed on the first clamping component or the second clamping component along a sliding direction; and a brake assembly, disposed on the second clamping component or the first clamping component, comprising at least a brake component movably mounted on the slide component, with a brake end of the brake component movable between an engaging position and an disengaging position of the locking tooth.

In the above retaining clip, the brake component in the locking mechanism is applied a biasing force that tends to press the brake end towards the locking teeth, and the locking teeth are one-way teeth that are engaged with the brake end to allow the movement in the clamping direction and prevent the movement in the releasing direction.

In the above retaining clip, the brake component is pivotally mounted on a sliding component related thereto, and the biasing force is provided by a torsion spring.

In the above retaining clip, the brake component is formed with a pivoting structure that comprises a fixing base fixed on the sliding component related thereto, and a pivot provided on the fixing base, and the brake is rotatably disposed relative to the fixed base through the pivot.

In the above retaining clip, the retaining clip further comprises a biasing mechanism for driving the clamping surfaces of the first clamping component and the second clamping component to separate from each other.

In the above retaining clip, the biasing force mechanism comprises a first spring base provided on the first clamping component or the second clamping component;

a second spring base provided on the second clamping component or the first clamping component; and a biasing force spring provided between the first spring base and the second spring base.

In the above retaining clip, the biasing force spring is a compression spring.

In the above retaining clip, the first spring base is further provided with a supporting rod for supporting the biasing force spring.

In the above retaining clip, the first clamping component comprises a first sliding component extending towards the second clamping component; and the second clamping component comprises a second sliding component extending towards the first clamping component; and the first sliding component and the second sliding component are connected so as to be slidable only in an extending direction thereof.

In the above retaining clip, the first sliding component is a sliding column, the second sliding component is a sliding sleeve slidably sleeved on the sliding column; and the fixing base is provided at a position where the sleeve corresponds to the locking teeth.

In the above retaining clip, the side of the locking teeth that faces the clamping surface of the first clamping component is arranged on the sliding column.

In the above retaining clip, the locking teeth are provided on the sliding column on both sides of the clamping surfaces of the first clamping component, and the retaining clip comprises two sets of brake assemblies that are arranged corresponding to the locking teeth on both sides, respectively.

In the above retaining clip, the first spring base is provided in an inner cavity of the sliding column; the second spring base is provided in an inner cavity of the sliding sleeve; and the biasing spring is provided in the inner cavities of the sliding column and the sliding sleeve between the first spring base and the second spring base.

The above retaining clip further comprises a limiting structure for preventing the first clamping component from slipping relative to the second clamping component.

In the above retaining clip, the limiting structure comprises a limiting slot formed on the sliding column along an arrangement direction of the locking teeth; a limiting block slidably engaged with the limiting slot and fixedly disposed on the sliding sleeve so as to guide the sliding of the first clamping component.

In the above retaining clip, a shim plate is provided on the clamping surface of the second clamping component.

In the above retaining clip, the first clamping component and the second clamping component are respectively provided with a gap compensating component, which resiliently presses a clamped device.

In the above retaining clip, the gap compensating component is a soft rubber pad.

The above retaining clip further comprises a fill light interface, which is provided on the first clamping component.

The above retaining clip further comprises a Bluetooth handle slot, which is provided on the second clamping component.

The above retaining clip further comprises a threaded interface provided on the first clamping component or the second clamping component, for being connected the fixed supporting device.

In the above retaining clip, the first clamping component and the second clamping component have a damping structure provided therebetween, which allows a slow movement of the first clamping component relative to the second clamping component.

In the above retaining clip, the sliding column and the sliding sleeve have a damping oil provided therebetween.

In the above retaining clip, the threaded interface is provided on at a bottom of the second clamping component.

In the retaining clip according to the present invention, since the brake end of the brake component may be driven to move between an engaging position and an disengaging position of the locking teeth, thus when the first clamping component and the second clamping component need to be locked, the user just needs to move the brake end to the engaging position where the first clamping component and the second clamping component may not move relative to each other; when the relative position of the first clamping component and the second clamping component needs to be adjusted, the user just needs to move the brake end to an disengaging position where the first clamping component and the second clamping component may move relative to each other without being locked by the locking mechanism. Therefore, in the present embodiment, the braking component is used to directly brake the lock teeth, which is easier than the brake modes of using the push-button, gears and the rack transmission in the prior art, thereby contributing to the reduction of the production cost, and to reduce the size of the clips.

### BRIEF DESCRIPTION OF THE DRAWINGS

In order to more clearly illustrate the specific embodiments of the invention or the technical solutions in the prior art, the following drawings, which are intended to be used in the description of the specific embodiments or the prior art, will be briefly described, and it will be apparent that the following description, apparently, the drawings are some of the embodiments of the present invention, and for those skilled in the art, other drawings may be obtained from these drawings without paying creative work.

FIG. 1 is a schematic vertical cross-sectional view of a retaining clip according to the first embodiment of the present invention;

FIG. 2 is a schematic view of a three-dimensional structure of a retaining clip according to the first embodiment of the present invention;

FIG. 3 is a schematic view of a three-dimensional structure of a retaining clip of the second embodiment according to the present invention;

FIG. 4 is a schematic cross-sectional view of a retaining clip of the first embodiment according to the present invention;

FIG. 5 is a schematic view showing a state of using a retaining clip of the first embodiment according to the present invention;

FIG. 6 is a back view of FIG. 5;

FIG. 7 is a schematic view of a retaining clip in an open state in the first embodiment of the present invention, in which a mobile phone is not placed in the retaining clip;

FIG. 8 is a schematic view of a retaining clip in an open state in the first embodiment of the present invention, in which a mobile phone is placed in the retaining clip;

FIG. 9 is a schematic view of a retaining clip in the first embodiment of the present invention, wherein the first clamping component is pressed downward to make a mobile phone clamped by the retaining clip;

FIG. 10 is a schematic view of a retaining clip in the first embodiment of the present invention, wherein a brake end is pressed so that first clamping component is movable relative to the second clamping component;

FIG. 11 is a schematic view of a retaining clip in the first embodiment of the present invention, wherein after the brake end is pressed, the first clamping component moves upward to release the clamping of a mobile phone;

FIG. 12 is a schematic view of a retaining clip in the second embodiment of the present invention, wherein the retaining clip is in the open state and a mobile phone is not placed into the retaining clip;

FIG. 13 is a schematic view of a retaining clip in the second embodiment of the present invention, wherein the retaining clip is in the open state and a mobile phone is placed into the retaining clip;

FIG. 14 is a schematic view of a retaining clip in the second embodiment of the present invention, wherein the first clamping component is pressed downward to make a mobile phone clamped by the retaining clip;

FIG. 15 is a schematic view of a retaining clip in the second embodiment of the present invention, wherein a brake end is pressed so that first clamping component is movable relative to the second clamping component;

FIG. 16 is a schematic view of a retaining clip in the second embodiment of the present invention, wherein after the brake end is pressed, the first clamping component moves upward to release the clamping of a mobile phone.

A description of the reference signs in the drawings is given as below:

10—first clamping component; 20—second clamping component; 21—thread interface; 31—one-way locking teeth; 32—brake component; 33—first biasing component; 322—brake end; 321—pressing end; 323—fixing base; 324—pivot; 311—limiting slot; 312—limiting block; 43—soft rubber pad; 41—first spring base; 42—second spring base; 43—biasing force spring; 411—supporting bar; 51—fill light interface; 52—Bluetooth handle slot; 53—shim plate.

### DETAILED DESCRIPTION OF EMBODIMENTS

The technical solution of the invention will now be described in details below with reference to the accompanying drawings, obviously, the described embodiments are part of the present invention, not all the embodiments. Based on the embodiments in the present invention all other embodiments obtained by those skilled in the art without making creative effort are within the scope of the present invention.

To be sure, in the description of the present invention, the terms “center”, “upper”, “lower”, “left”, “right”, “vertical”, “horizontal”, “inside”, “outer” indicates that the azimuth or positional relationship is based on the azimuth or positional relationship shown in the accompanying drawings only for the purpose of facilitating and simplifying the description of the invention, rather than indicating or implying that the means or elements referred to must have a specific orientation in a particular orientation and be constructed and operated in a particular orientation, therefore cannot be construed to limit the scope of the present invention. In addition, the terms “first”, “second”, and “third” are provided for purposes of descriptions only and should not be construed to indicate or imply relative importance.

To be sure, in the description of the present invention, unless otherwise specified and defined, the terms “install”, “connect”, “connect” should be broadly understood, for example, it may be a fixed connection, a detachable connection, or an integral connection; it may be a mechanical connection or an electrical connection; it may be directly connected or indirectly connected by an intermediate medium, or may be the internal connection of two components. Those skilled in the art understand the specific meaning of the above terms in the present invention in light of specific circumstances.

In addition, the technical features described in the different embodiments of the present invention described below may be combined with each other as long as there is no conflict between them.

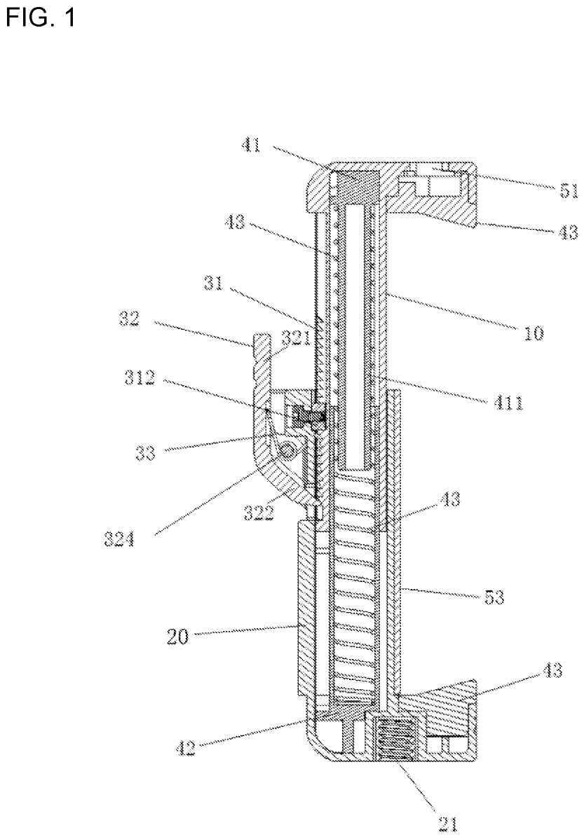

Referring to FIG. 1, the present embodiment provides a retaining clip for champing a device such as a mobile phone, a card camera, and the like, mainly for a photographic camera field, comprising a first clamping component 10; a second clamping component 20, which is movably connected with the first clamping component 20, as shown in FIG. 1, a track is formed in the second clamping component 20, the first clamping component 10 is inserted into the second clamping component 20 and slidable along the track; however, it is clear that the movable connection is not limited to the above-mentioned one, for example, the second clamping component 20 may be formed with one or several sliding slots, and the first clamping component 10 may be movably provided on a sliding slot by means of balls, rollers, etc., and brief examples are not exemplified here. And the first clamping component 10 and the second clamping component 20 respectively have a clamping surface facing each other in a moving direction thereof; the locking mechanism comprises locking teeth 31, disposed on the first clamping component 10 along a sliding direction; and a brake assembly, disposed on the second clamping component 20, comprising at least a brake component 32 movably mounted on the slide component, with a brake end 332 of the brake component 32 movable between an engaging position and an disengaging position of the locking tooth 31.

As a preferred technical scheme of the present embodiment, the brake component 32 in the locking mechanism is applied a biasing force that tends to press the brake end 332 towards the locking teeth 31, and the locking teeth 31 are one-way teeth that are engaged with the brake end 322 to allow the movement in the clamping direction and prevent the movement in the releasing direction. The brake component 32 is pivotally mounted on a sliding component related thereto, and the biasing force is provided by a torsion spring. The brake component 32 is formed with a pivoting structure that comprises a fixing base 323 fixed on the sliding component related thereto, and a pivot 324 provided on the fixing base 323, and the brake 32 is rotatably disposed relative to the fixed base 323 through the pivot 324. A biasing force mechanism for separating the champing surfaces of the first clamping component 10 and the second clamping component 20 from each other is provided between the first clamping component 10 and the second clamping component 20. The first spring base 41 is provided on the first clamping component 10; the second spring base 42 is provided on the second clamping component 20; and a biasing force spring 43 is provided between the first spring base 41 and the second spring base 42. The biasing force spring 43 is a compression spring. The first spring base 41 is further provided with a supporting rod for supporting the biasing force spring. The first clamping component 10 comprises a first sliding component extending towards the second clamping component 20; and the second clamping component 20 comprises a second sliding component extending towards the first clamping component 10; and the first sliding component and the second sliding component are connected so as to be slidable only in an extending direction thereof. In particular, it is preferable that the first sliding component is a sliding column, the second sliding component is a sliding sleeve slidably sleeved on the sliding column; and the fixing base 323 is provided at a position where the sleeve corresponds to the locking teeth 31. The side of the locking teeth 31 that faces the clamping surface of the first clamping component 10 is arranged on the sliding column. The first spring base 41 is provided in an inner cavity of the sliding column; the second spring base 42 is provided in an inner cavity of the sliding sleeve; and the biasing spring 43 is provided in the inner cavities of the sliding column and the sliding sleeve between the first spring base 41 and the second spring base 42. The retaining clip further comprises a limiting structure for preventing the first clamping component 10 from slipping relative to the second clamping component 20. The limiting structure comprises a limiting slot 311 formed on the sliding column along an arrangement direction of the locking teeth 31; a limiting block 312 slidably engaged with the limiting slot 311 and fixedly disposed on the sliding sleeve so as to guide the sliding of the first clamping component 10. A shim plate 53 is provided on the clamping surface of the second clamping component 20. The first clamping component 10 and the second clamping component 20 are respectively provided with a soft rubber pad 43.

As an alternative embodiment, the locking teeth 31 are not limited to one-way teeth, and when the locking teeth are selected as two-way teeth or irregular teeth, it is only necessary to disengage the brake end 322 from the locking teeth 31 when only the relative position of the first clamping component 10 and the second clamping component 20 is to be adjusted; in other words, the arrangement of one-way teeth makes the adjustment process easier.

As an alternative embodiment, the locking teeth 31 are provided on the spool of both sides of the clamping surfaces of the first clamping component 10, and the braking assemblies are provided into two groups and are respectively provided corresponding to both sides of the locking teeth 31. And the height of the two sets of brake assemblies may be the same or different to accommodate the operation.

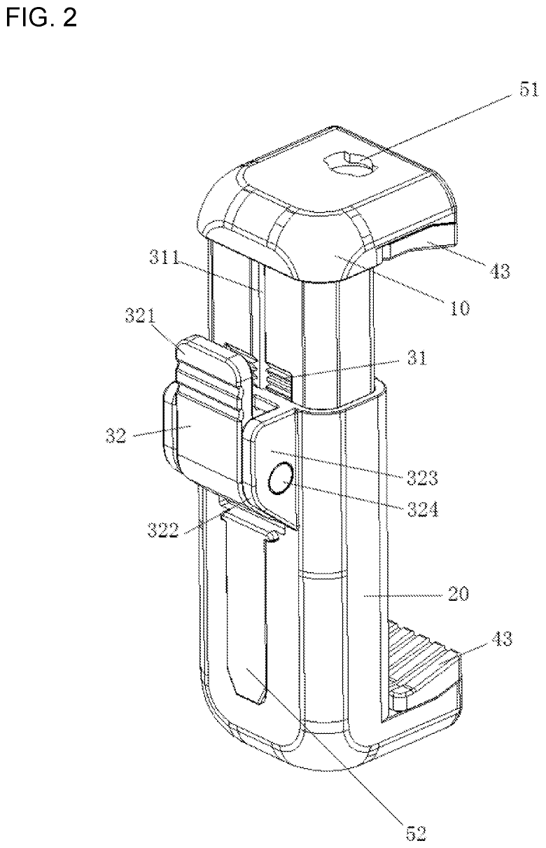

As an alternative embodiment, as shown in FIG. 1 and FIG. 2, the locking teeth 31 are provided on the first clamping component 10, but the locking teeth 31 may be provided on the second clamping component 20, in this case, it is only necessary to provide the locking mechanism on the first clamping component 10, although this arrangement is not shown in the drawings, however, those skilled in the art may achieve it in view of the above description.

In the above embodiment, since the brake end 322 of the brake component 32 may be driven to move between an engaging position and an disengaging position of the locking tooth 31, thus when the first clamping component 10 and the second clamping component 20 need to be locked, the user just needs to move the brake end 322 to an engaging position, where the first clamping component 10 and the second clamping component 20 cannot move relative to each other; when the relative position of the first clamping component 10 and the second clamping component 20 needs to be adjusted, the user just needs to move the brake end 322 to an disengaging position where the first clamping component 10 and the second clamping component 20 may move relative to each other without being locked by the locking mechanism. Therefore, in the present embodiment, the braking component 32 is directly used to brake the locking teeth 31, which is easier than the brake modes of using the push-button, gears and the rack transmission in the prior art, thereby contributing to the reduction of the production cost, and to reduce the size of the clips.

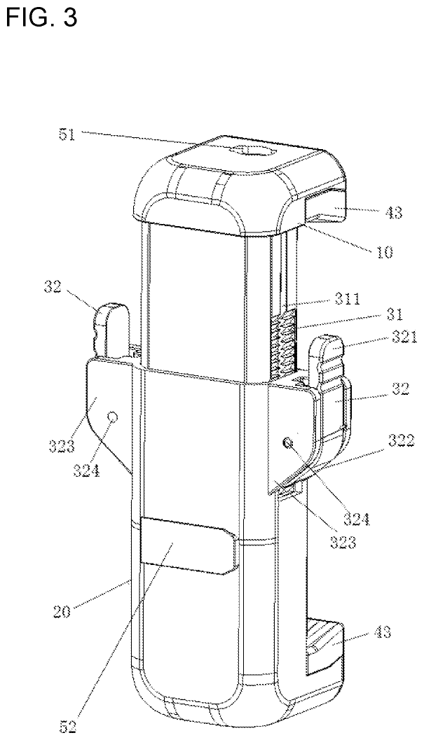

In the above embodiment, the locking teeth 31 are provided in two ways, the first being arranged as the side of the locking teeth 31 facing the clamping surface of the first clamping component 10, the other being provided on both sides of the clamping surfaces, that is to say, the clamping surfaces of the first clamping component 10, which are specifically shown in FIG. 2 and FIG. 3, respectively. Further, a shim plate 53 is provided on the clamping surface of the second clamping component 20 to adjust the position of the apparatus on the clamping surface.

In the present embodiment, it is preferable that the brake component 32 is a bent plate structure having a brake end 322 and a pressing end 321, and it is further preferable that the bending angle of the bent plate is such that the brake end 322 and the one-way teeth are in contact with each other, the pressing end 321 is in a vertical state, thereby facilitating the pressing operation.

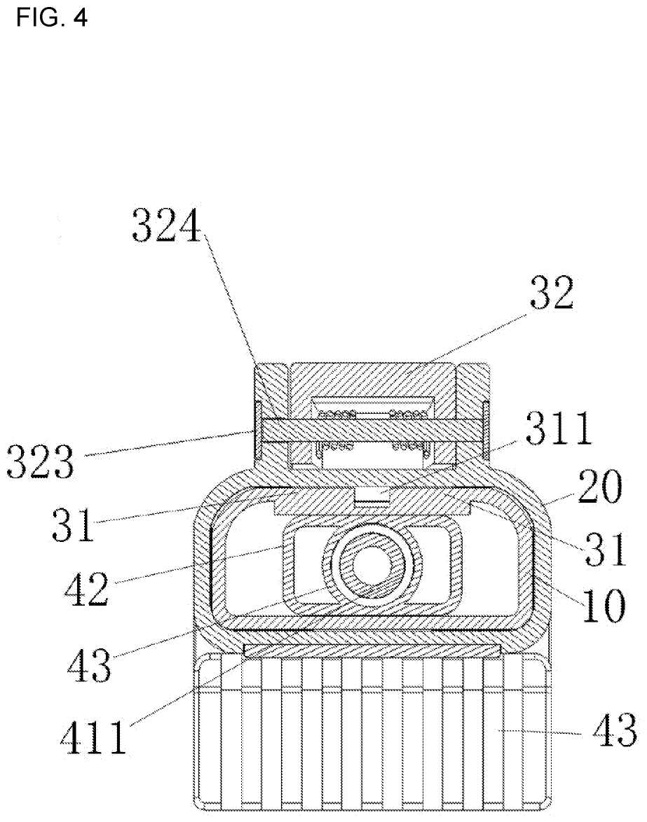

In the present embodiment, as shown in FIG. 4, the brake assembly further comprises a fixing base 323 formed on the second clamping component 20, and a pivot 324 provided on the fixing base 323. Specifically, the fixing base 323 may be two mounting plates with coaxial mounting holes, and the pivot 324 is fixedly provided in the mounting holes and is rotatably connected to the brake component 32, and a pivot side cover for closing the mounting hole is provided at both ends of the pivot 324. Alternatively, the pivot 324 is rotatably provided in the mounting holes and fixedly connected to the brake component 32, which plays the same role of making the brake component 32 being rotatably disposed relative to the one-way teeth 31.

In the present embodiment, a limiting structure is also provided for providing a guide to the relative sliding between the first champing component 10 and the second champing component 20, which makes the structure more stable. The limiting structure comprises a fixed limiting block 312 and a limiting slot 311 formed on the first clamping component 10 and cooperating with the limiting block 312, thus when the first clamping component 10 is moved relative to the second clamping component 20, the limiting slot 311 is also moved relative to the limiting block 312, in one embodiment, the width of the limiting slot 311 is slightly larger than that of the limiting block 312, thereby playing the role of guiding and a limiting. As shown in FIG. 2 and FIG. 3, the limiting slot 311 and the limiting block 312 may be provided at the intermediate position and the one-way teeth 31 are divided into two sections, but it needs to be noted that the limiting slot 311 and the limiting block 312 may be provided on one side of the one-way teeth 31, and it is only necessary that the lengthwise direction of the limiting slot 311 and the direction of movement of the first champing component 10 are uniform. As may be seen from the above, the limiting structure of the present embodiment includes only the limiting slot 311 and the limiting block 312, and the structure is relatively simple; and the limiting slot 311 and the limiting block 312 are located outside the retaining clip thus to achieve the role of providing limitation and orientation in the situation that the difficulty of processing conditions does not become higher.

In the present embodiment, in order to firmly champ devices such as a mobile phone or the like, the first clamping component 10 and the second clamping component 20 are respectively provided with a gap compensating component, the relative distance between the two clamping surfaces in this embodiment is adjusted by the one-way teeth 31 and the minimum adjustment accuracy of the one-way teeth 31 is the teeth pitch, which makes it possible for the clamped component to be in a state where it cannot be clamped, therefore, the above gap compensating component is designed to adjust the relative distance. As a preferred the gap compensating component, after resiliently deformed, the self-restoring force of the soft pad 43 is able to continue to clamp the device.

In the present embodiment, the first clamping component 10 and the second clamping component 20 have a damping structure provided therebetween, in particular, under the action of the biasing force spring 43, if the damping structure is not provided, the first champing component 10 will quickly bounce when the brake assembly is unlocked, which is unfavorable to the positioning operation. Therefore, it is necessary to provide a damping structure between the first champing component 10 and the second champing component 20, as an preferred design, the damping structure may be a structure such as a damping oil provided between the sliding column and the sliding sleeve; as a substitution, the damping structure may also be a resilient interlayer and other structures capable of providing damping, which is not repeated one by one herein.

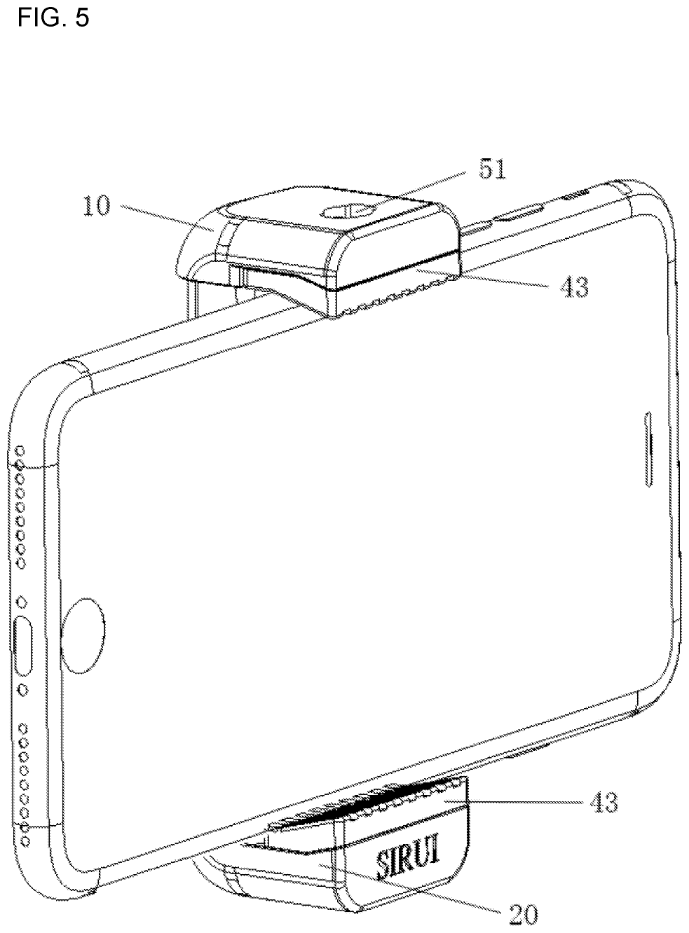

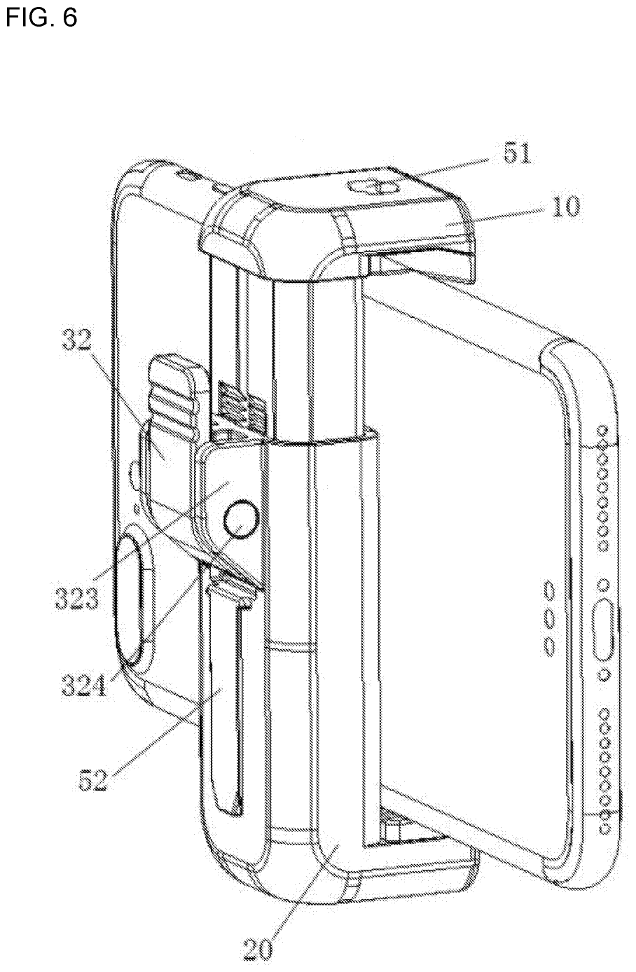

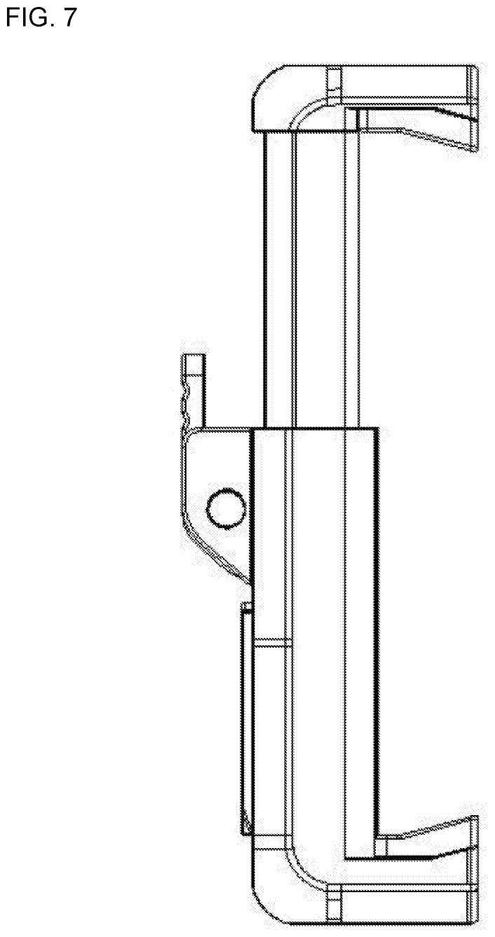

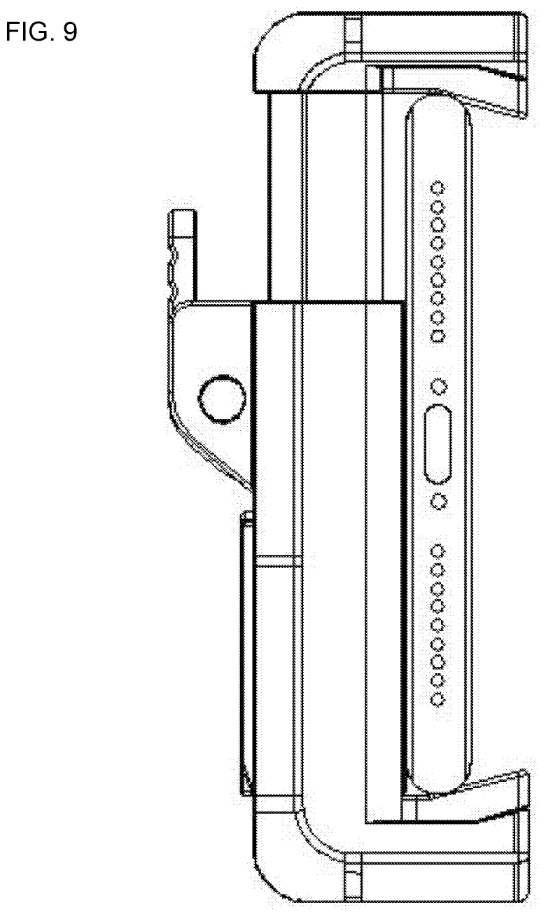

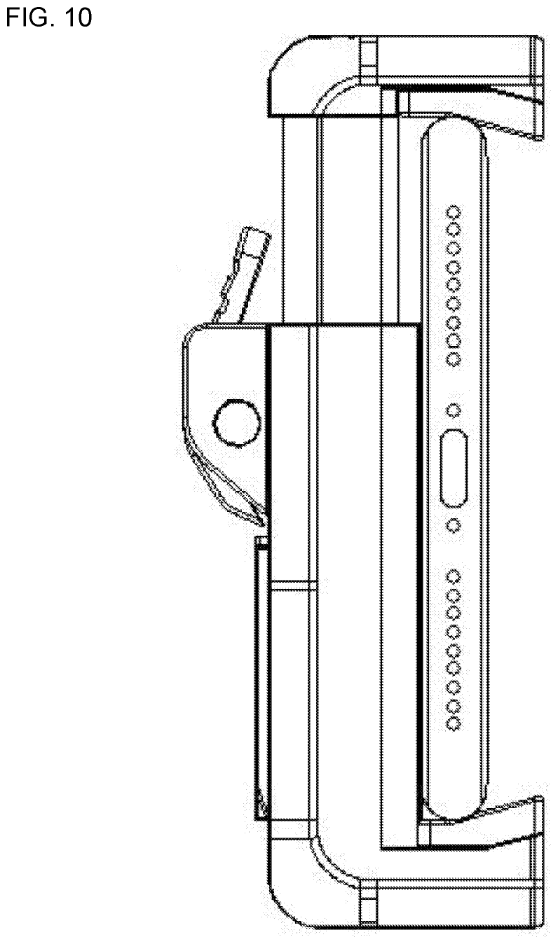

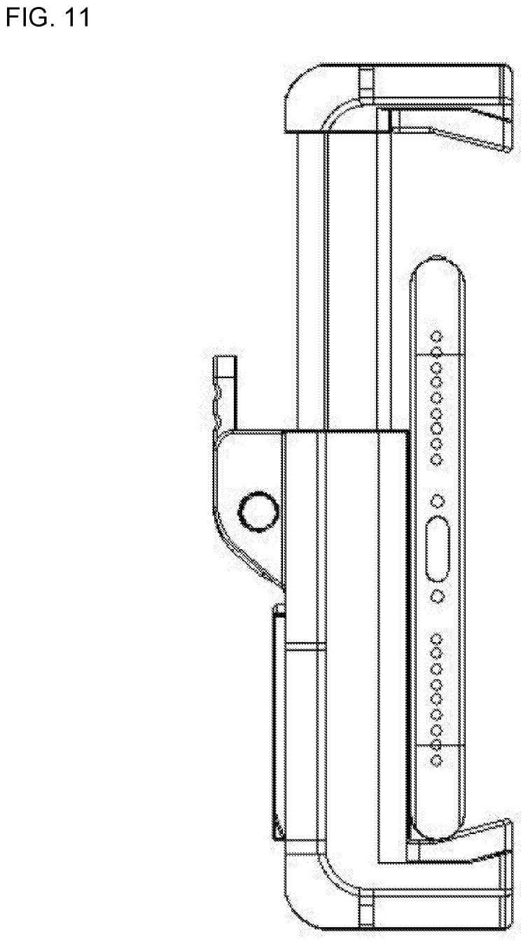

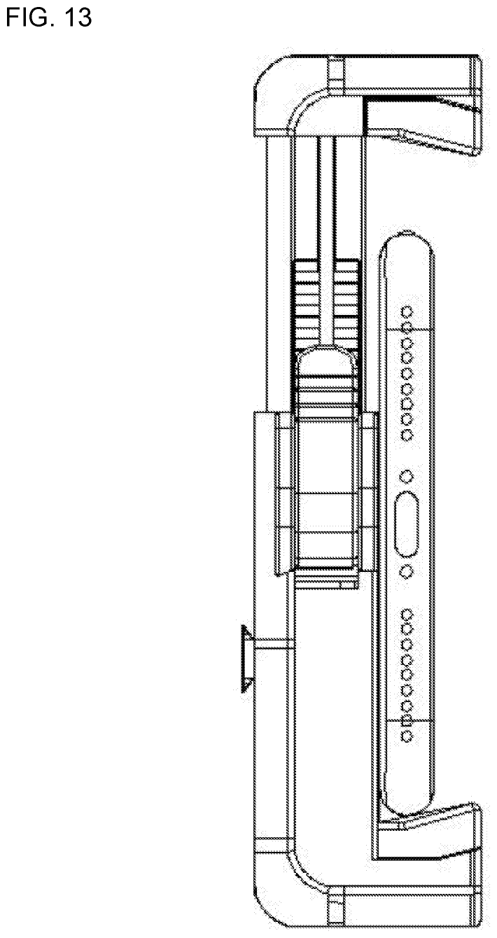

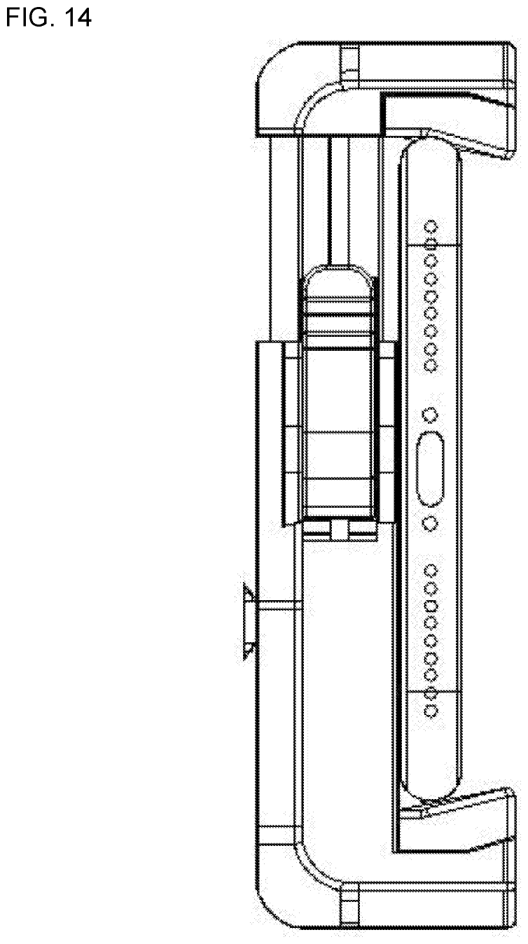

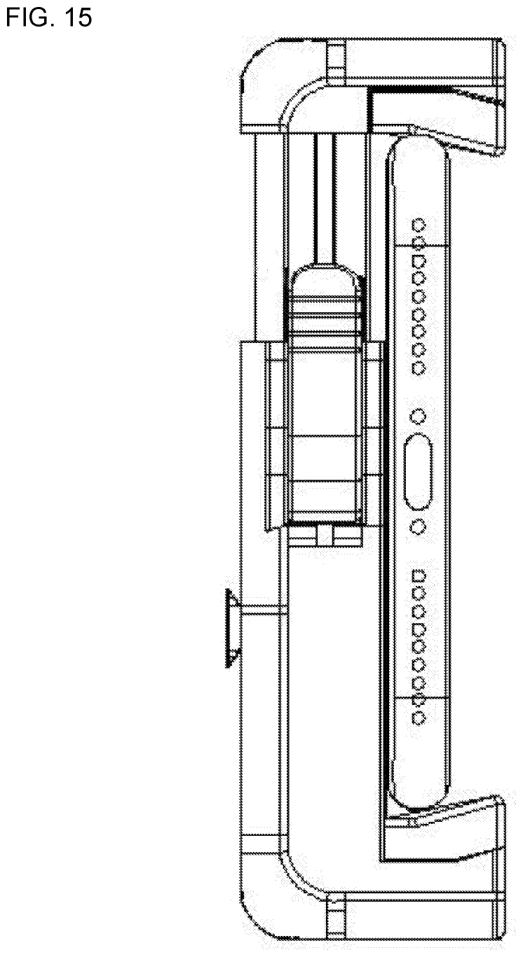

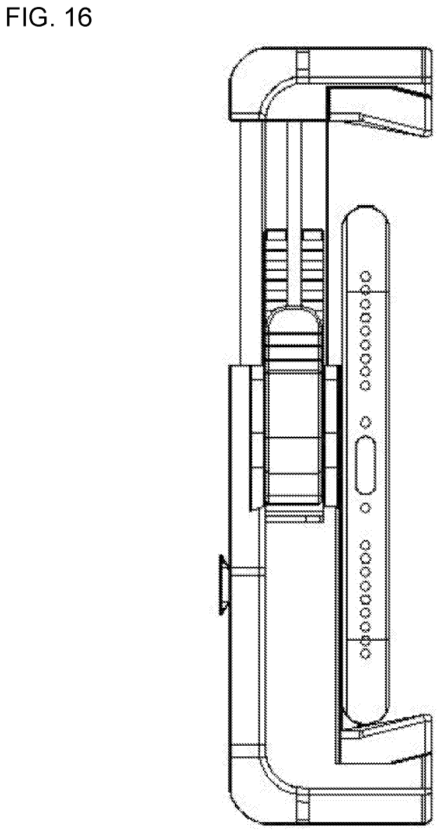

In the present embodiment, a biasing force mechanism for maintaining a biasing force of the first champing component 10 and the second champing component 20 is provided for the convenience of the user, specifically refer to the procedures for using the retaining clip of the present embodiment described particularly in FIG. 5 to FIG. 16, which illustrate the role of the biasing force mechanism.

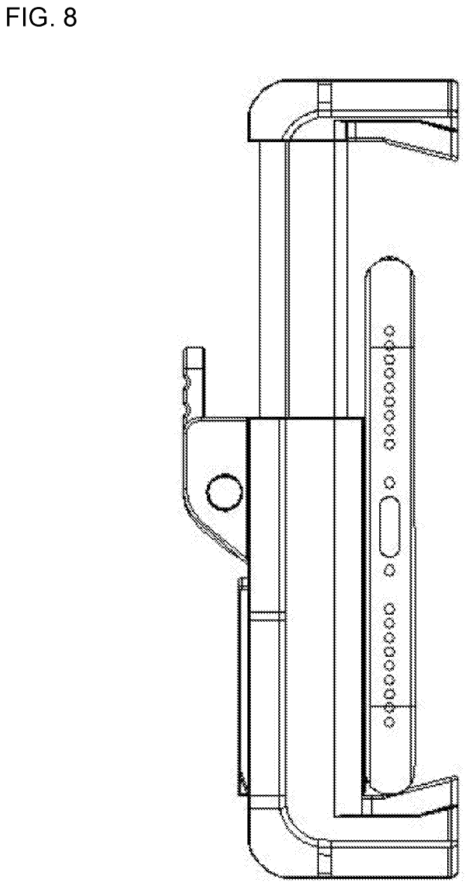

Firstly, referring to FIGS. 5-11, under the action of the biasing force mechanism, the first champing component 10 is opened to the limit position with respect to the second champing component 20, and the mobile phone is placed between the first champing component 10 and the second champing component, since the locking teeth 31 and the brake end 322 are in a one-way contact, when the locking teeth 31 are moved downward, the brake end 322 cannot act as a hindrance, then the mobile phone will be securely lock between the two soft rubber pads 43 by manually press the first champing component 10 to move downward. Referring to FIG. 8, when the lock is released, the pressing end 321 of the brake component 32 is pressed, and the brake end 322 of the brake component 32 is tilted away from the locking teeth 31, and the first champing component 10 will move upward by the biasing force mechanism to release the clamping effect on the phone.

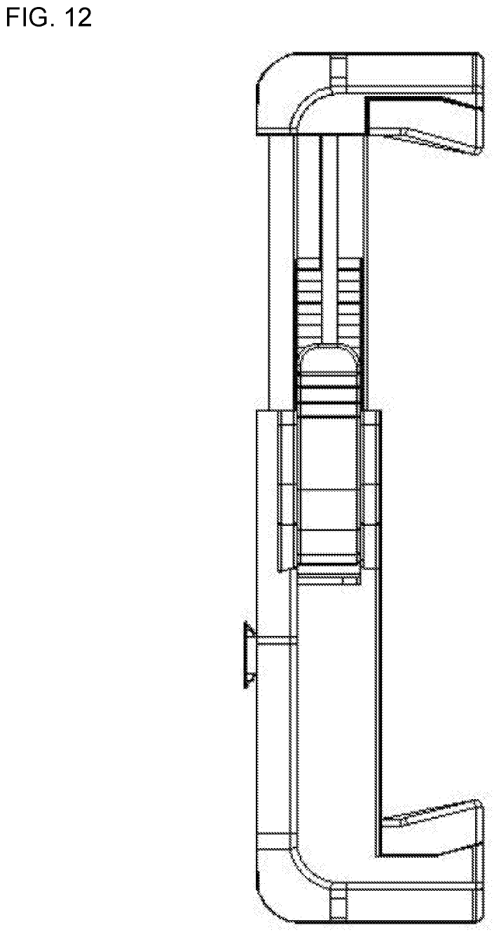

Then referring to FIGS. 12-16, in the same manner as described above, when the mobile phone needs to be unlocked, the brake component 32 on both sides are pressed so that the brake end 322 of the brake component 32 is tilted away from the lock teeth 31, and the first champing component 10 will move upward by the biasing force mechanism to release the clamping effect on the phone.

In the present embodiment, referring to FIG. 1, the biasing force mechanism further comprises a supporting rod 411 for supporting the biasing force spring provided on the first spring base 41, and, in one embodiment, the length of the supporting rod 411 is such that the supporting rod 411 abuts against the second spring base 42 of the second champing component 20 when the first clamping component 10 is moved downwardly to the limit position.

In the present embodiment, referring to FIG. 2, when the brake assembly is provided on the back of the clamping surface, the Bluetooth handle slot 52 is, in one embodiment, provided vertically below the brake assembly; when the brake assembly is provided on both sides of the clamping surface, the Bluetooth handle slot 52 is, in one embodiment, provided horizontally on the back of the clamping surface. It is apparent that the position of the Bluetooth handle slot 52 is not only the above two forms, but it is clear that a skilled person in the art may make a reasonable selection, which is not repeated one by one herein.

In addition, a fill light interface 51 is provided on the top of the first clamping component 10, which enables the retaining clip of the present embodiment to provide a better photographic effect.

In the above embodiment, the first clamping component 10 and the second clamping component 20 are respectively rectangular, and it needs to be noted that the shape of the first clamping component 10 and the second clamping component 20 may be changed depending on the practical requirements of the product, for example, in the form of a cylinder, a triangle, or the like.

In one embodiment, a threaded interface provided on the first clamping component (10) or the second clamping component (20), for being connected the fixed supporting device.

In the embodiment, where the threaded surface may be used, the threaded interface may be provided on at a bottom of the second clamping component (20). In another embodiment, the first clamping component (10) and the second clamping component (20) may have a damping structure provided therebetween, which allows a slow movement of the first clamping component (10) relative to the second clamping component (20). In yet another embodiment, the sliding column and the sliding sleeve have a damping oil provided therebetween.

It is obvious that the above-described embodiments are merely illustrative of the examples given and are not intended to limit the manner in which it is implemented. It will be apparent to those skilled in the art to make various other changes or variations on the basis of the above description. There is no need and it is not possible to exhaust all the implementation herein. And the obvious changes or variations that have been extended are still within the scope of protection of the present invention.

What is claimed is:

1. A retaining clip, comprising:
a first clamping component (10);
a second clamping component (20), which is movably connected with the first clamping component (20), wherein, the first clamping component (10) and the second clamping component (20) respectively have a clamping surface facing each other in a moving direction thereof;
a locking mechanism, for locking a piece clamped between the clamping surfaces of the first clamping component (10) and the second clamping component (20) and releasing the locking of the piece clamped;
wherein the locking mechanism comprises:
locking teeth (31), disposed on the first clamping component (10) or the second clamping component (20) along a sliding direction; and
a brake assembly, disposed on the second clamping component (20) or the first clamping component (10), comprising at least a brake component (32) movably mounted on the slide component, with a brake end (332) of the brake component (32) movable between an engaging position and an disengaging position of the locking tooth (31).

2. The retaining clip of claim 1, wherein the brake component (32) in the locking mechanism is applied a biasing force that tends to press the brake end (332) towards the locking teeth (31), and the locking teeth (31) are one-way teeth that are engaged with the brake end (322) to allow the movement in the clamping direction and prevent the movement in the releasing direction.

3. The retaining clip of claim 2, wherein the brake component (32) is pivotally mounted on a sliding component related thereto, and the biasing force is provided by a torsion spring.

4. The retaining clip of claim 3, wherein the brake component (32) is formed with a pivoting structure that comprises a fixing base (323) fixed on the sliding component related thereto, and a pivot (324) provided on the fixing base (323), and the brake (32)) is rotatably disposed relative to the fixed base (323) through the pivot (324).

5. The retaining clip of claim 1, wherein the retaining clip further comprises a biasing mechanism for driving the clamping surfaces of the first clamping component (10) and the second clamping component (20) to separate from each other.

6. The retaining clip of claim 5, wherein the biasing force mechanism comprises:
a first spring base (41) provided on the first clamping component (10) or the second clamping component (20);
a second spring base (42) provided on the second clamping component (20) or the first clamping component (10); and
a biasing force spring (43) provided between the first spring base (41) and the second spring base (42).

7. The retaining clip of claim 6, wherein the biasing force spring (43) is a compression spring.

8. The retaining clip of claim 7, wherein the first spring base (41) is further provided with a supporting rod for supporting the biasing force spring.

9. The retaining clip of claim 1, wherein the first clamping component (10) comprises a first sliding component extending towards the second clamping component (20); and the second clamping component (20) comprises a second sliding component extending towards the first clamping component (10); and the first sliding component and the second sliding component are connected so as to be slidable only in an extending direction thereof.

10. The retaining clip of claim 9, wherein the first sliding component is a sliding column, the second sliding component is a sliding sleeve slidably sleeved on the sliding column; and the fixing base (323) is provided at a position where the sleeve corresponds to the locking teeth (31).

11. The retaining clip of claim 10, wherein the side of the locking teeth (31) that faces the clamping surface of the first clamping component (10) is arranged on the sliding column.

12. The retaining clip of claim 10, wherein the locking teeth (31) are provided on the sliding column on both sides of the clamping surfaces of the first clamping component (10), and the retaining clip comprises two sets of brake assemblies that are arranged corresponding to the locking teeth (31) on both sides, respectively.

13. The retaining clip of claim 10, wherein the first spring base (41) is provided in an inner cavity of the sliding column; the second spring base (42) is provided in an inner cavity of the sliding sleeve; and the biasing spring (43) is provided in the inner cavities of the sliding column and the sliding sleeve between the first spring base (41) and the second spring base (42).

14. The retaining clip of claim 1, characterized in further comprising a limiting structure for preventing the first clamping component (10) from slipping relative to the second clamping component (20).

15. The retaining clip of claim 14, wherein the limiting structure comprises:
a limiting slot (311) formed on the sliding column along an arrangement direction of the locking teeth (31); and
a limiting block (312) slidably engaged with the limiting slot (311) and fixedly disposed on the sliding sleeve so as to guide the sliding of the first clamping component (10).

16. The retaining clip of claim 1, wherein a shim plate (53) is provided on the clamping surface of the second clamping component (20).

17. The retaining clip of claim 1, wherein the first clamping component (10) and the second clamping component (20) are respectively provided with a gap compensating component, which resiliently presses a clamped device.

18. The retaining clip of claim 17, wherein the gap compensating component is a soft rubber pad (43).

19. The retaining clip of claim 1, further comprising a fill light interface (51), which is provided on the first clamping component (10).

20. The retaining clip of claim 1, further comprising a Bluetooth handle slot (52), which is provided on the second clamping component (20).
